(19) United States
(12) Patent Application Publication
(10) Pub. No.: US 2007/0103904 A1
(43) Pub. Date: May 10, 2007

(54) Light emitting diode lamp

(76) Inventor: Ching-Chao Chen, Hsinchu City (TW)

Correspondence Address: TROXELL LAW OFFICE PLLC, SUITE 1404, 5205 LEESBURG PIKE, FALLS CHURCH, VA, 22041, US

(21) Appl. No.: 11/269,722

(22) Filed: Nov. 9, 2005

(51) Int. Cl. F21V 23/04

(52) U.S. Cl. 362/276

(57) ABSTRACT

A light emitting diode lamp is disclosed to include a lamp base connectable to a lamp socket, a bulb fastened to the top side of the lamp base, and a light emitting diode lamp voltage-dropping circuit module fixedly mounted in the holding space inside the lamp base and holding light emitting diode close to the bottom end of the bulb for enabling the light emitted by the light emitting diode to pass to the outside through the whole area of the bulb.

### BACKGROUND AND SUMMARY OF THE INVENTION

The present invention relates to lamps and more particularly, to a light emitting diode lamp, which comprises a lamp base, a bulb fastened to the lamp base, and a light emitting diode lamp voltage-dropping circuit module mounted inside the lamp base and holding a light emitting diode close to the bottom end of the bulb to prevent an illumination dead angle, allowing the light emitted by the light emitting diode to pass to the outside through the whole area of the bulb.

FIGS. 1 and 2 show a conventional light emitting diode lamp 6. The light emitting diode lamp 6 comprises a lamp base 61, a bottom bulb shell 602 fastened to the lamp base 61, a circuit board 62 mounted inside the bottom bulb shell 602 and electrically coupled to the threaded ring contact 611 and tip contact (not shown) of the lamp base 61, a light emitting diode 63 installed in the circuit board 62, and top bulb shell 601 fastened to the bottom bulb shell 602. According to this design, the threaded ring contact 611 of the lamp base 61 can be fastened to a conventional lamp socket 7 for Christmas tree light string (see FIG. 3) or a conventional lamp socket and plug assembly 8. This light emitting diode lamp 6 may be decorated with a lamp-shaped ornament 80 before installation in a conventional lamp socket and plug assembly 8. After connection of the lamp-shaped ornament 80 to the light emitting diode lamp 6, the threaded ring contact 611 of the lamp base 61 extends out of the bottom opening 801 of the lamp-shaped ornament 80 for fastening to the lamp socket and plug assembly 8. This design of light emitting diode lamp 6 is still not satisfactory in function because of the following drawbacks:

1. Because the body 630 of the light emitting diode 63 is suspending in the center area in the holding space surrounded by the bottom bulb shell 602 and the top bulb shell 601, the circuit board 62 blocks the light of the light emitting diode 63 from passing to the outside through the bottom bulb shell 602.

2. The circuit board 62 has installed therein related electronic component parts such as capacitor 621, resistor 622 and voltage stabilizing diode 623. These electronic component parts 621, 622, 623 block a part of the light of the light emitting diode 63, thereby lowering the brightness of the light emitting diode lamp 6.

3. Because the bottom bulb shell 602 and the top bulb shell 601 are transparent, the electronic component parts 621, 622, 623 are visible from the outside, i.e., the visible electronic component parts 621, 622, 623 destruct the sense of beauty of the light emitting diode lamp 6.

Mounting the electronic component parts 621, 622, 623 in the bottom side of the circuit board 62 can eliminate the aforesaid second and third drawbacks. However, because the lamp base 61 has many different specifications in different countries, for example, E26, E17 and E12 in USA and Canada, E27, E14 and E10 in West Germany and some other European countries. According to E12, the lamp base has an outer diameter about 12 mm and an inner diameter about 10 mm. According to E10, the lamp base has an outer diameter about 10 mm and an inner diameter about 8 mm. The limited inside space of the lamp base provides no room for so many electronic component parts 621, 622, 623.

FIG. 6 shows another design of light emitting diode lamp 9 according to the prior art. According to this design, the light emitting diode lamp 9 comprises a bulb 90, a lamp base 91, a holder frame 94 joining the bulb 90 and the lamp base 91, a circuit board 92 mounted inside the holder frame 94, and a plurality of light emitting diodes 93 installed in the circuit board 92. The circuit board 92 has the related electronic component parts including capacitor 921, resistor 922 and voltage stabilizing diode 923 mounted in the bottom side. Therefore, these electronic component parts 921, 922, 923 do not block the light of the light emitting diodes 93 or are kept from sight by the holder frame 94. However, this design of light emitting diode lamp 9 still has drawbacks as follows:

1. It wastes much time and labor to join the holder frame 94, the bulb 90 and the lamp base 91.

2. Because the holder frame 94 does not admit light, it blocks a part of the light emitted by the light emitting diodes 93, lowering the brightness of the light emitting diode lamp 9.

3. An extra molding mold is necessary for molding the holder frame 94, increasing the manufacturing cost of the light emitting diode lamp 9.

The present invention has been accomplished under the circumstances in view. According to one aspect of the present invention, the light emitting diode lamp comprises a lamp base connectable to a lamp socket, a bulb fastened to the top side of the lamp base, a light emitting diode lamp voltage-dropping circuit module, and a light emitting diode installed in the top side of the light emitting diode lamp voltage-dropping circuit module. The light emitting diode lamp voltage-dropping circuit module is fixedly mounted in the holding space inside the lamp base, and the light emitting diode is kept close to the bottom end of the bulb to prevent an illumination dead angle, allowing the light emitted by the light emitting diode to pass to the outside through the whole area of the bulb. According to another aspect of the present invention, there is no other electronic component parts provided above the elevation of the topmost edge of the lamp base except the light emitting diode, therefore the light emitting diode lamp causes a sense of beauty and, the light emitted by the light emitting diode passes through the whole area of the bulb to the outside, providing a high brightness. According to still another aspect of the present invention, the light emitting diode lamp voltage-dropping circuit module has a small size and can be installed in the holding space inside the lamp base, which is made subject to any of a variety of specifications.

### BRIEF DESCRIPTION OF THE DRAWING

FIG. 1 is a perspective view of a light emitting diode lamp according to the prior art.

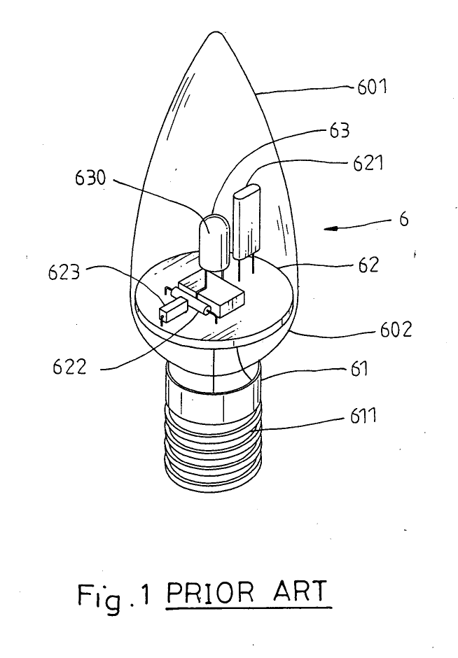

FIG. 2 is a sectional view of the light emitting diode lamp shown in FIG. 1.

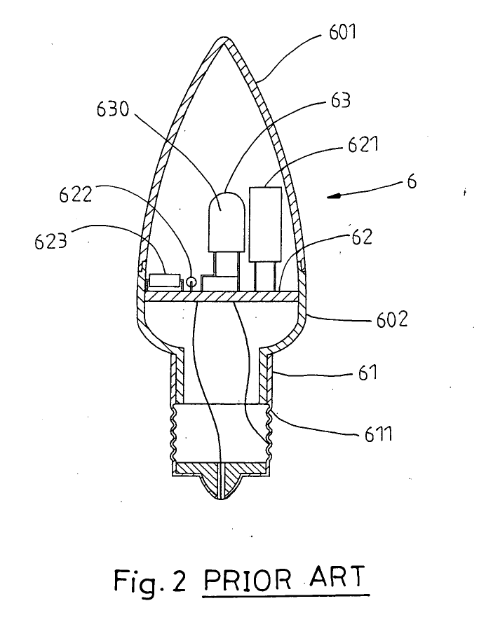

FIG. 3 illustrates the use of the prior art light emitting diode lamp of FIG. 1 with a conventional lamp socket for Christmas tree light string.

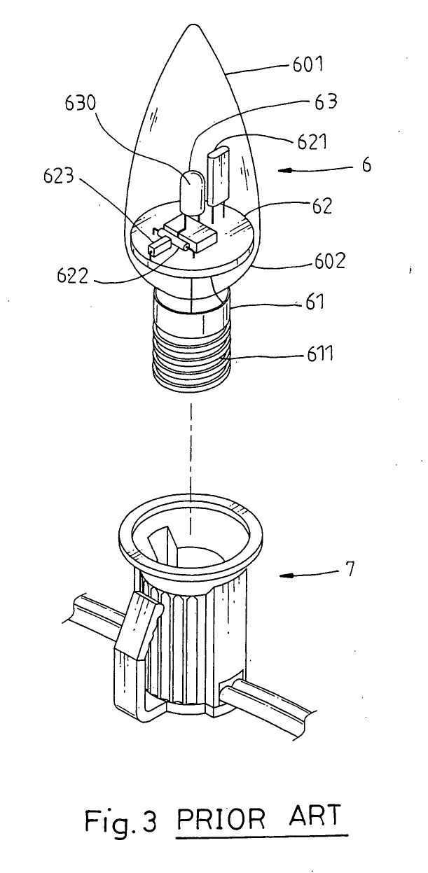

FIG. 4 illustrates the use of the prior art light emitting diode lamp of FIG. 1 with a conventional lamp socket and plug assembly.

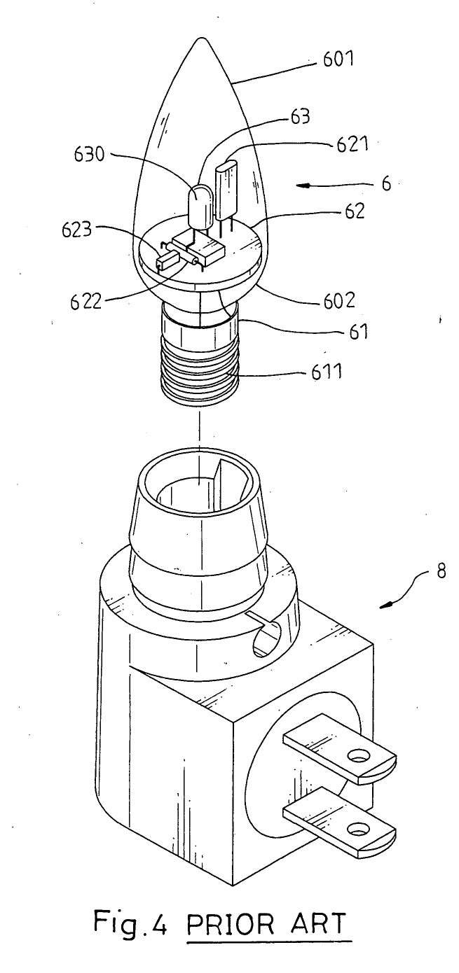

FIG. 5 illustrates the prior art light emitting diode lamp of FIG. 1 decorated with a lamp-like ornament for use with a conventional electric socket and plug assembly.

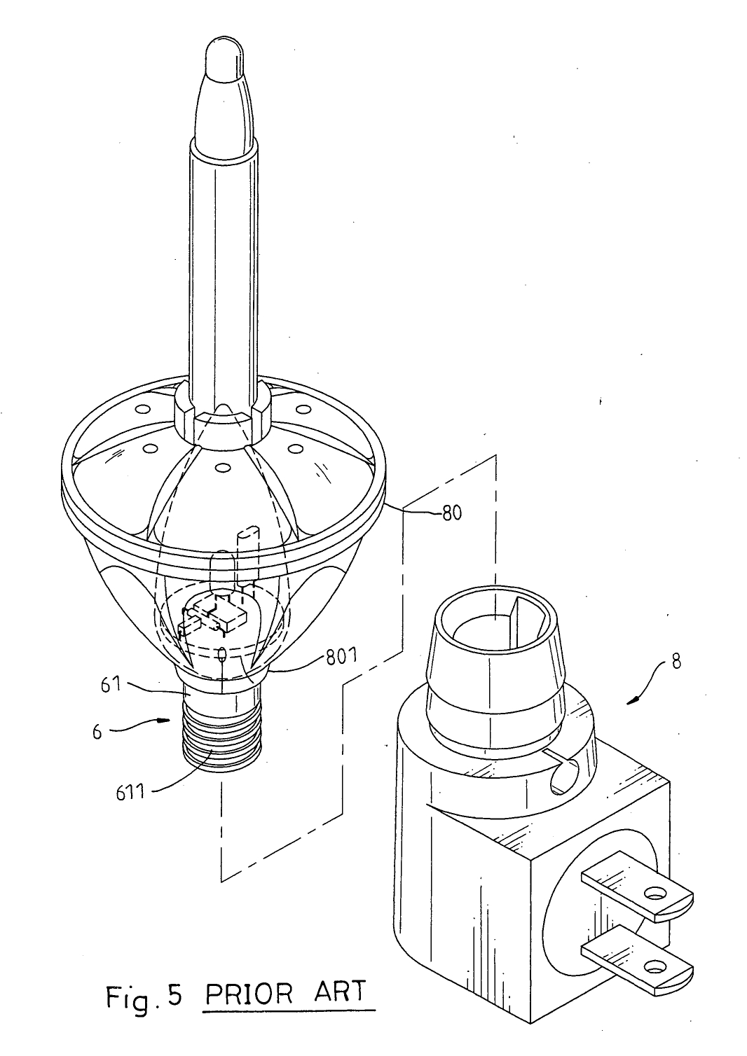

FIG. 6 is a sectional view of another design of light emitting diode lamp according to the prior art.

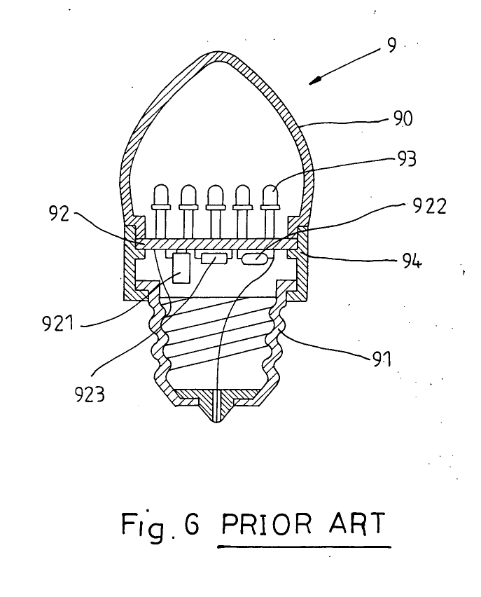

FIG. 7 is a perspective view of a light emitting diode lamp according to the present invention.

FIG. 8 is a sectional view of the light emitting diode lamp according to the present invention.

### DETAILED DESCRIPTION OF THE INVENTION

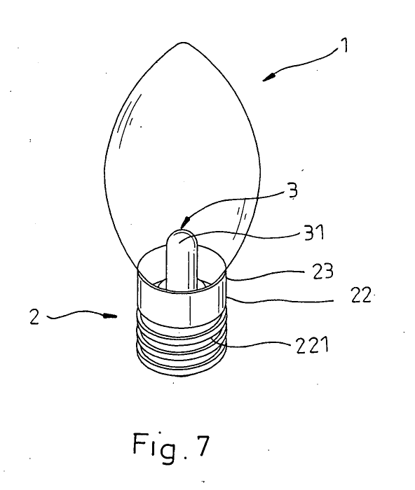

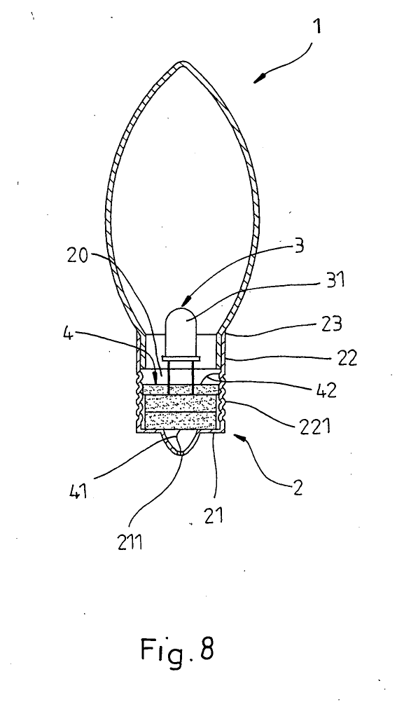

Referring to FIGS. 7 and 8, a light emitting diode lamp in accordance with the present invention is shown comprising a lamp base 2, a bulb 1 fastened to the top end of the lamp base 2, and a light emitting diode 3 mounted in the lamp base 2 and suspending in the bulb 1. The lamp base 2 is a hollow cylindrical member having a bottom wall 21, a peripheral wall 22 extending around the periphery of the bottom wall 21, an outer thread 221 extending around the peripheral wall 22 for fastening to a lamp socket (not shown), a negative electrode 42 installed in the peripheral wall 22, and a positive electrode 41 installed in the center of the bottom wall 21.

Referring to FIG. 8 again, the light emitting diode 3 is installed in a light emitting diode lamp voltage-dropping circuit module 4, which is mounted in the holding space 20 inside the lamp base 2 and adapted to drop the input voltage to a suitable voltage level for the light emitting diode 3. Further, the light emitting body 31 of the light emitting diode 3 is kept close to the bottom end of the bulb 1. Therefore, the light emitted by the light emitting body 31 of the light emitting diode 3 pass to the outside through the whole area of the bulb 1. Because there is no any other electronic component parts above the topmost edge 23 of the lamp base 2, the light emitted by the light emitting body 31 of the light emitting diode 3 pass through the whole area of the bulb 1 to the outside. Therefore, the light emitting diode lamp has a high brightness. Further, because the light emitting diode lamp voltage-dropping circuit module 4 has a small size, it can be installed in the holding space 20 inside the lamp base 2, which is made subject to any of a variety of specifications such as E26, E17 and E12 in USA and Canada, E27, E14 and E10 in West Germany and some other European countries.

Further, the aforesaid positive electrode 41 and negative electrode 42 are respectively electrically connected to the positive and negative terminals of the light emitting diode lamp voltage-dropping circuit module 4.

In the aforesaid embodiment, only one light emitting diode 3 is installed in the voltage-dropping circuit module 4. Alternatively, multiple light emitting diodes 3 can be used and installed in the voltage-dropping circuit module 4 to increase the brightness of the light emitting diode lamp. Further, the light emitting diode 3 can be a chip light emitting diode.

Further, the aforesaid light emitting diode lamp voltage-dropping circuit 4 comprises a circuit board (not shown), and the aforesaid light emitting diode 3 and an integrated circuit (not shown) installed in the circuit board.

As indicated above, the invention provides a light emitting diode lamp, which has the following features:

1. The light emitting diode 3 is installed in the top side of the light emitting diode lamp voltage-dropping circuit module 4, which is fixedly mounted in the holding space 20 inside the lamp base 2, and the light emitting body 31 of the light emitting diode 3 is kept close to the bottom end of the bulb 1 to prevent an illumination dead angle, allowing the light emitted by the light emitting body 31 of the light emitting diode 3 to pass to the outside through the whole area of the bulb 1.

2. Except the light emitting diode 3, there is no other electronic component parts provided above the elevation of the topmost edge 23 of the lamp base 2, therefore the light emitting diode lamp causes a sense of beauty and, the light emitted by the light emitting diode 3 passes through the whole area of the bulb 1 to the outside, providing a high brightness.

3. The light emitting diode lamp voltage-dropping circuit module 4 has a small size and can be installed in the holding space 20 inside the lamp base 2, which is made subject to any of a variety of specifications.

What is claimed is:

1. A light emitting diode lamp comprising:
a lamp base, said lamp base having a bottom wall, a peripheral wall extending around the periphery of said bottom wall and defining with said bottom wall a holding space, an outer thread extending around said peripheral wall for fastening to a lamp socket, a negative electrode installed in said peripheral wall, and a positive electrode installed in the center of said bottom wall;
a bulb, said bulb having a bottom side fastened to the top side of said lamp base; and
at least one light emitting diode;
wherein said at least one light emitting diode is respectively installed in a light emitting diode lamp voltage-dropping circuit module, which is mounted in said holding space inside said lamp base to hold said at least one light emitting diode close to the bottom end of said bulb for enabling the light emitted by said at least one light emitting diode to pass through the whole area of said bulb to the outside of the light emitting diode lamp.

2. The light emitting diode lamp as claimed in claim 1, wherein said light emitting diode lamp voltage-dropping circuit module has a positive terminal and a negative terminal respectively electrically coupled to said positive electrode and said negative electrode.

3. The light emitting diode lamp as claimed in claim 1, wherein said at least one light emitting diode each is a chip light emitting diode.
